(19) United States
(12) Patent Application Publication
(10) Pub. No.: US 2025/0246987 A1
(43) Pub. Date: Jul. 31, 2025

(54) METHODS AND APPARATUS TO SYNCHRONIZE MULTI-PHASE CONVERTERS

(71) Applicant: Texas Instruments Incorporated, Dallas, TX (US)

(72) Inventors: Orlando Lazaro, Cary, NC (US); Chandradevi Ulaganathan, McKinney, TX (US)

(21) Appl. No.: 18/429,002

(22) Filed: Jan. 31, 2024

(51) Int. Cl. H02M 1/00; H02M 1/15

(52) U.S. Cl. CPC H02M 1/0041; H02M 1/0025; H02M 1/007; H02M 1/0095; H02M 1/15

(57) ABSTRACT

An example apparatus to control a power stage circuit includes: programmable circuitry configured to: generate, in response to an instruction from an external controller, a pulse in a first local clock signal, the pulse in the first local clock signal generated when a fly capacitor in the power stage circuit has discharged for a discharge period that is less than a threshold amount of time; and generate a pulse in a second local clock signal after the fly capacitor has charged for a charge period, wherein a length of the charge period is based on the length of the discharge period.

### TECHNICAL FIELD

This description relates generally to power converters, and, more particularly, to methods and apparatus to synchronize multi-phase converters.

### BACKGROUND

Power management is a critical design component of any electronic device. In general, power management circuitry refers to hardware within an electronic device that converts a first amount of power received from a source into a second amount of power that is consumable by a load within the electronic device. Power sources may include, but are not limited to, 120 Volts alternating current (VAC) or 240 VAC outlets, batteries, generators, solar energy from the sun, etc. Generally, power management circuitry may additionally convert the power from a first type (e.g., alternating current (AC)) to a second type (e.g., direct current (DC)) that is usable by the load.

### SUMMARY

For methods and apparatus to synchronize multi-phase converters, an example apparatus includes: programmable circuitry configured to: generate, in response to an instruction from an external controller, a pulse in a first local clock signal, the pulse in the first local clock signal generated when a fly capacitor in the power stage circuit has discharged for a discharge period that is less than a threshold amount of time; and generate a pulse in a second local clock signal after the fly capacitor has charged for a charge period, wherein a length of the charge period is based on the length of the discharge period.

### BRIEF DESCRIPTION OF THE DRAWINGS

FIG. 1 is an example of power delivery that includes multi-phase buck regulator circuitry.

FIG. 2 is an example block diagram of the multi-phase buck regulator circuitry of FIG. 1.

FIG. 3 is an example block diagram of the local controller circuitry of FIG. 2.

FIG. 4 is an example block diagram of the power stage circuitry of FIG. 2.

FIG. 5 is an example timing diagram of signals produced by the local controller circuitry and power stage circuitry of FIG. 2.

FIG. 6 is an example of a timing diagram including signals produced by the ramp generator circuitry and clock manager circuitry of FIG. 3.

FIG. 7 is a first example block diagram of the clock manager circuitry of FIG. 3.

FIG. 8 is a second example block diagram of the clock manager circuitry of FIG. 3.

FIG. 9 is an example timing diagram of signals produced by the clock manager circuitry of FIGS. 7 and 8.

FIG. 10 is a flowchart representative of example machine-readable instructions and/or example operations that may be executed, instantiated, and/or performed using an example programmable circuitry implementation of the local controller circuits of FIG. 2.

FIG. 11 is a flowchart representative of example machine-readable instructions and/or example operations that may be executed, instantiated, and/or performed using an example programmable circuitry implementation of the clock manager circuitry of FIG. 3.

FIG. 12 is a block diagram of an example processing platform including programmable circuitry structured to execute, instantiate, and/or perform the example machine-readable instructions and/or perform the example operations of FIGS. 10 and 11 to implement the local controller circuitry 206A and/or, more generally, the controller circuitry 202 of FIG. 2.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

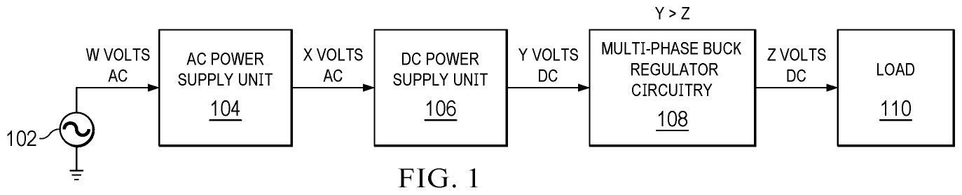

FIG. 1 is an example of power delivery that includes multi-phase buck regulator circuitry. FIG. 1 includes a power source 102, an AC power supply unit 104, a DC power supply unit 106, multi-phase buck regulator circuitry 108, and a load 110.

The power source 102 provides AC power. The power source 102 may be implemented by any device providing electrical energy in AC. For example, in FIG. 1, the example power source 102 is implemented by a 120 VAC outlet.

The AC power supply unit 104 transforms the 120 VAC into a different AC signal that is operable upon by the DC power supply unit 106. In particular, the AC power supply unit 104 may alter one or more of the voltage, frequency, shape of signal, number of phases, etc., depending on the type of the power source 102 and the requirements of the DC power supply unit 106.

The DC power supply unit 106 transforms the AC signal received from the AC powers supply unit 104 into a DC signal. The DC power supply unit 106 includes rectifier circuitry and filter circuitry to convert the AC signal to a DC signal. The DC power supply unit 106 is configured to provide a DC signal at a voltage that is operable by the multi-phase buck regulator circuitry 108. In some examples, the DC power supply unit 106 is referred to as a voltage source.

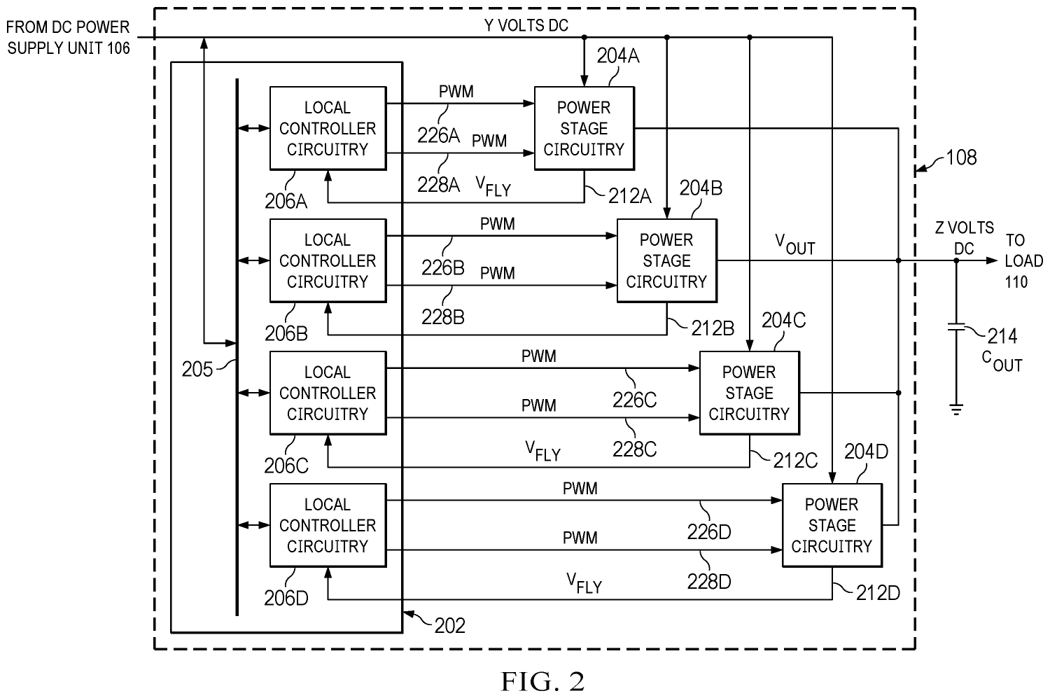

As described below, the example multi-phase buck regulator circuitry 108 is a voltage regulator circuit that transforms, in accordance with the teachings of this disclosure, the first DC voltage provided by the example DC power supply unit 106 into a second DC voltage usable by the load 110. The example multi-phase buck regulator circuitry 108 is discussed further in connection with FIG. 2.

In FIG. 1, the example load 110 is processor circuitry that uses the power from the second DC voltage to perform operations. In other examples, the load that receives the second DC voltage is another form of circuitry, including but not limited to a transceiver, volatile memory, etc. The example processor circuitry of load 110 may be implemented by any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

FIG. 2 is an example block diagram of the voltage regulator circuitry of FIG. 1. The example multi-phase buck regulator circuitry 108 of FIG. 1 includes example controller circuitry 202, which includes an example bus 205 and example local controller circuitry 206A, 206, 206C, and 206D (collectively referred to as local controller circuits 206). The example multi-phase buck regulator circuitry 108 also includes example power stage circuitry 204A, 204B, 204C, 204D (collectively referred to as power stage circuits 204), example pulse width modulation (PWM) signals 226A, 226B, 226C, 226D (collectively referred to as PWM signals 226), example PWM signals 228A, 228B, 228C, 228D (collectively referred to as PWM signals 228), example fly voltage (V_FLY) signals 212A, 212B, 212C, 212D (collectively referred to as V_FLY signals 212), and an example output capacitor 214. A fly voltage refers to the voltage across a fly capacitor as discussed further below.

The power stage circuits 204 deliver power to the load 110 based on pulses from the local controller circuits 206. A given power stage circuit 204A receives a constant input voltage from the example DC power supply unit 106 and two PWM signals 226A, 228A from a corresponding local controller circuit 206A. uses both PWM signals 226A, 228A to change the current and/or voltage of an output voltage (VOUT) signal provided to the load 110.

To perform the voltage and current transformation, the example power stage circuits 204 may include an inductor and one or more switches rated for high power. In examples described herein, a given power stage circuit 204A is a three-level buck converter circuit with a fly capacitor. Fly capacitors are explained below. More generally, the power stage circuits 204 may be implemented as any type of multi-level buck converter with a fly capacitor. In other examples, the power stage circuits 204 may be implemented with a different buck converter architecture that does not include a fly capacitor.

The fly capacitors within the power stage circuits 204 store different amounts of energy throughout a cycle of operation and help provide a desired voltage to the load 110. In particular, the power stage circuit 204A provides the voltage across the fly capacitor in the V_FLY signal 212A. The local controller circuitry 206A adjusts the timing of pulses within the PWM signals 226A and/or 228A based in part on the V_FLY signal 212A and in accordance with the teachings described herein. In some examples, a power stage circuit may be referred to as a phase converter circuit.

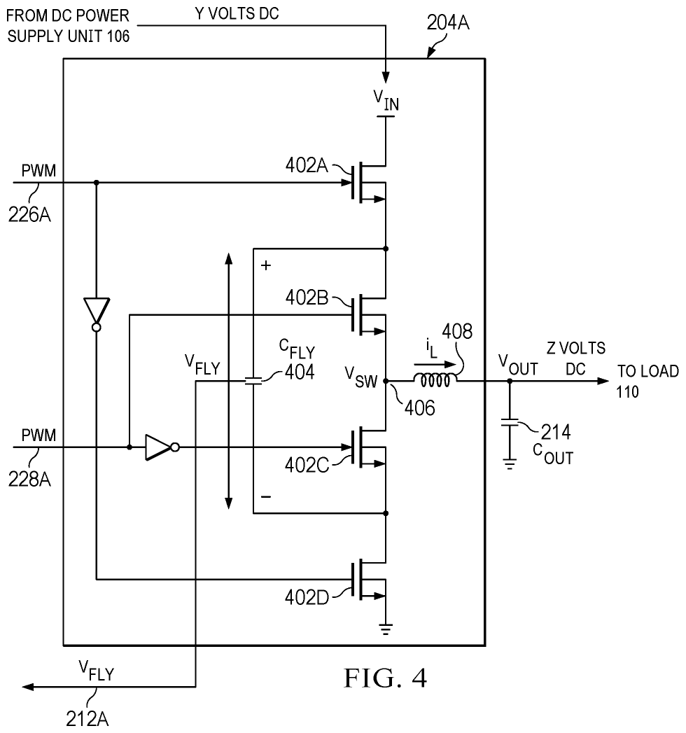

While FIG. 2 illustrates four power stage circuits 204 for simplicity, in practice, the multi-phase buck regulator circuitry 108 may include any number of power stage circuits. In some examples, the power stage circuits 204 are referred to as phase circuits. The power stage circuits 204 are discussed further in connection with FIG. 4.

The controller circuitry 202 coordinates the operations of the power stage circuits 204 as described herein. The controller circuitry 202 may be implemented by any type of programmable circuitry. In some examples, the controller circuitry 202 includes additional components besides the bus 205 and local controller circuits 206.

Within the example controller circuitry 202, the bus 205 refers to one or more physical connections (e.g., an interconnect, copper trace, etc.) that enables communication between the local controller circuits 206. The bus 205 may be implemented using one or more communication systems that meet pre-determined threshold power and latency requirements.

Within the example controller circuitry 202, the local control circuits 206 transmit the PWM signals 226A and 228A to corresponding power stage circuits 204. For example, the local controller circuitry 206A transmits the PWM signals 226A and 228A to the power stage circuitry 204A, the local controller circuitry 206B transmits the PWM signals 226B and 228B to the power stage circuitry 204B, etc. Both sets of PWM signals 226 and 228 include pulses that, when received by one of the power stage circuits 204, causes the power stage circuit to temporarily increase the current and provide power to the load 110 through the VOUT signal.

In some examples, one or more of the local controller circuits 206 may adjust the voltage and/or current of the VOUT signal based on the type of load 110. For example, suppose one or more components from FIG. 1 are implemented within a laptop. The one or more of the local controller circuits 206 may cause the corresponding power stage circuits 204 to provide more power in the VOUT signal when the laptop is in an active state (e.g., lid open and with several applications running) than when the laptop is in a sleep state (e.g., lid closed with several applications closed or idle). The local controller circuits 206 may be implemented by any type of programmable circuitry.

The power stage circuits 204 may exhibit error independently from one another in the sense that, at any given time, the amount of error within the output of the power stage circuitry 204A may be different from and unrelated to the amount of error within the output of the power stage circuitry 204B, etc. However, in many examples, specific performance metrics of the load 110 require the power stage circuits 204 provide coordinated outputs such that the VOUT signal is sufficiently timely and accurate.

Advantageously, the local controller circuits 206 communicate with one another in accordance with the teachings described herein to send PWM pulses such that a given local controller circuitry 206A transmits: a) one PWM signal that is globally synchronized with the other local controllers, and b) one PWM signal that is not globally synchronized. In examples described herein where the power stage circuits 204 are three-level buck converters, the PWM signals 226A and 228B are globally synchronized with one another to meet the performance requirements of the load 110 while the PWM signals 226B and 228A enable the correction of individual fly capacitor errors within the power stage circuits 204A and 204B. More generally, the teachings described herein enable individual local controllers 206 to transmit the one PWM signal that is not globally synchronized in a manner that is specific to the architecture of the corresponding power stage circuit. Such an ability enables the multi-phase buck regulator circuitry 108 to be implemented with more efficient and cost-effective PCB designs than previous solutions.

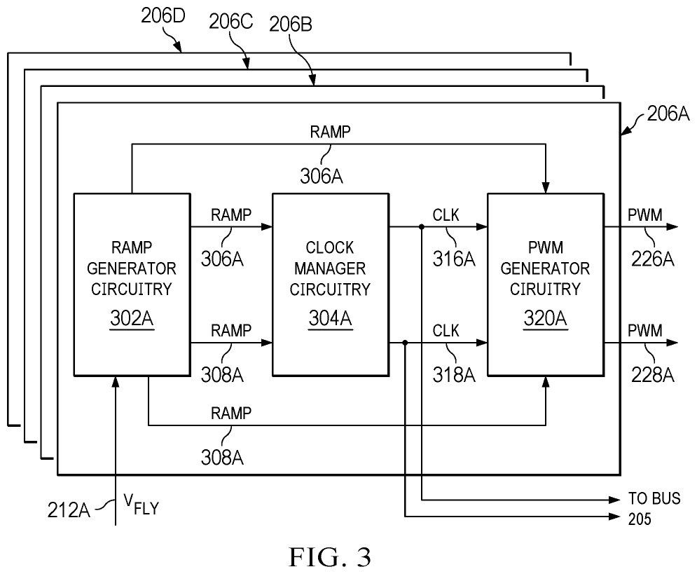

FIG. 3 is an example block diagram of the local controller circuitry 206A of FIG. 2. The local controller circuitry 206A includes example ramp generator circuitry 302A, example clock manager circuitry 304A, example PWM generator circuitry 320A, example ramp signals 306A, 308A and example clock signals 316A and 318A. The local controller circuitry 206A of FIG. 3 may be instantiated (e.g., creating an instance of, bring into being for any length of time, materialize, implement, etc.) by programmable circuitry such as a Central Processor Unit (CPU) executing first instructions. Additionally or alternatively, the local controller circuitry 206A of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

FIG. 3 also includes the local controller circuits 206B, 206C, 206D which each include a local instance of the foregoing components. That is, the local controller circuitry 206B includes example ramp generator circuitry 302B, example clock manager circuitry 304B, example ramp signals 306B, 308B, example clock signals 316B, 318B, etc. Furthermore, components within the local controller circuits 206B, 206C, 206D may operate according to the teachings described herein and discussed below in reference to local controller circuitry 206A.

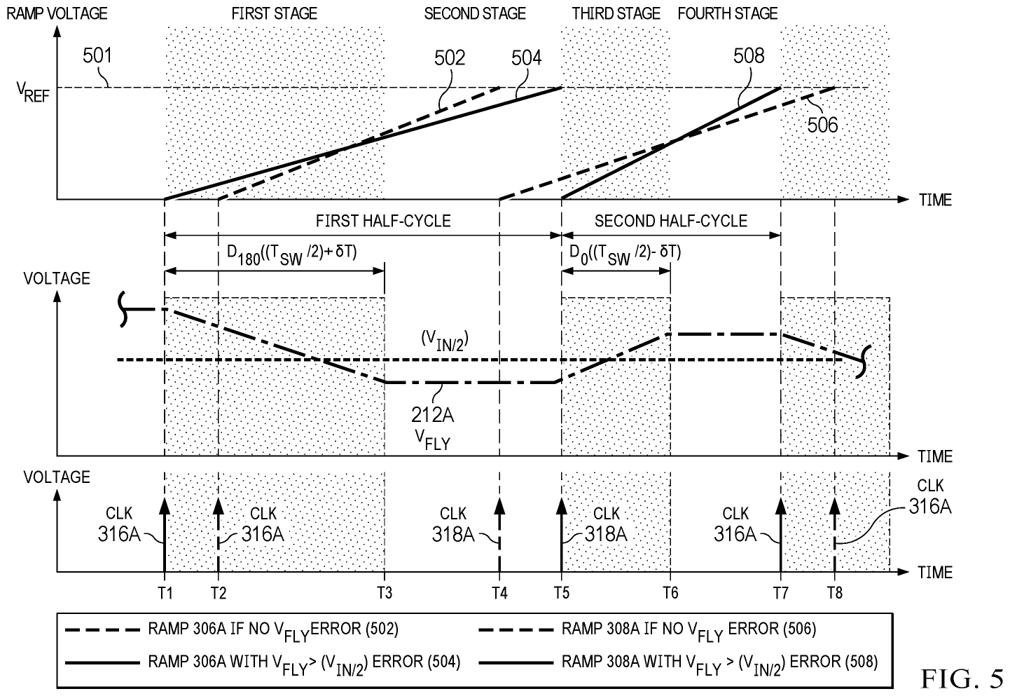

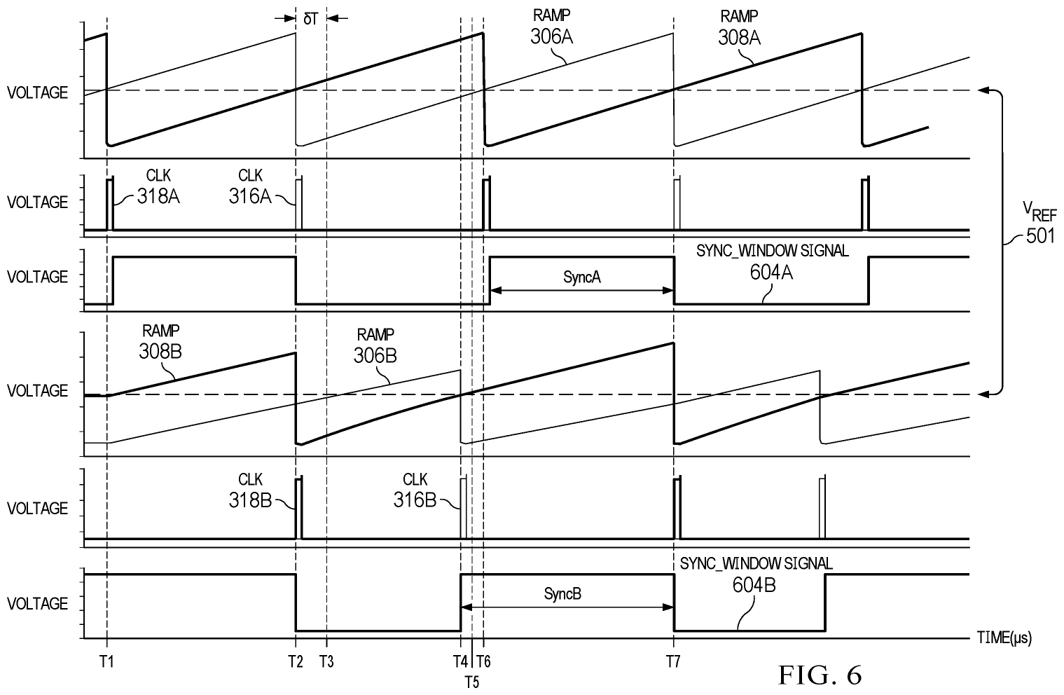

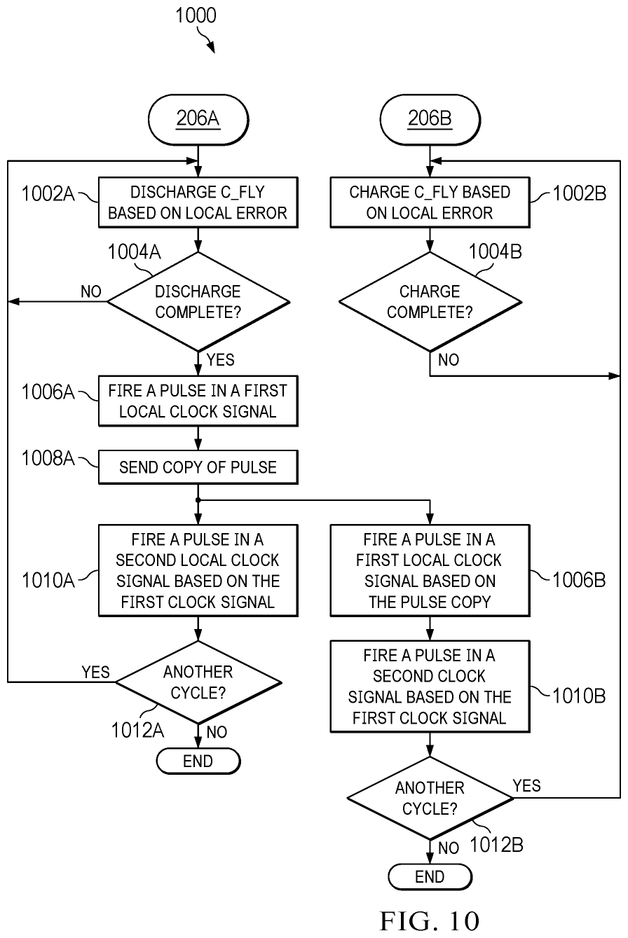

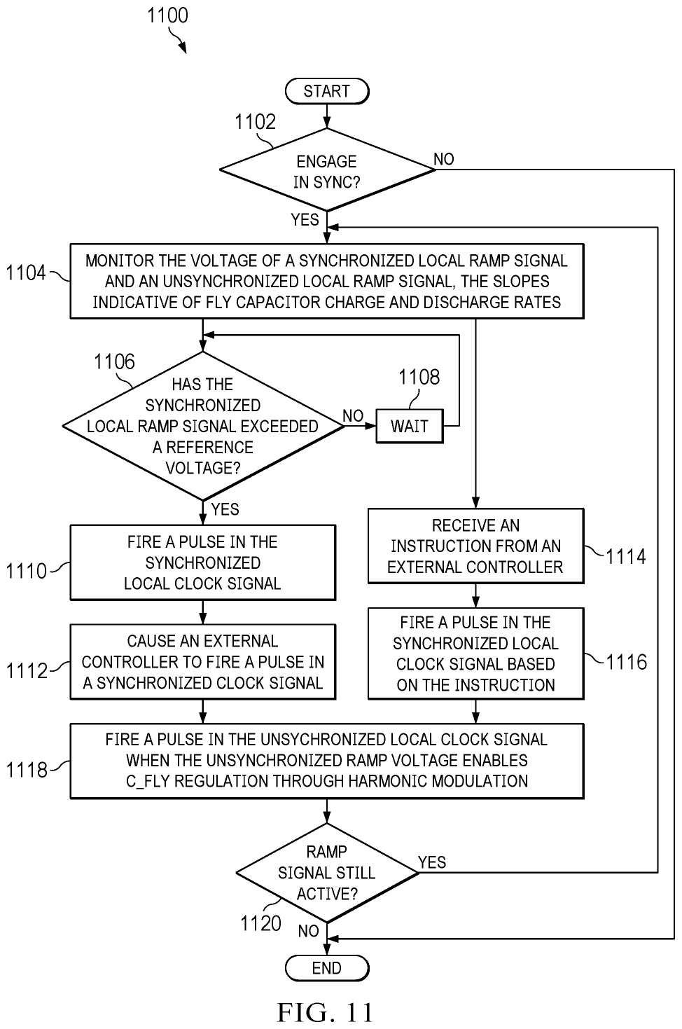

The example ramp generator circuitry 302A generates ramp signals 306A and 308A for use by the clock manager circuitry 304A to generate the clock signals 316A and 318A. The ramp generator circuitry 302A produces the ramp signals 306A and 308A with their slopes modulated based on the V_FLY signal 212A. As such, the voltage within the ramp signals is based on error that exists within the power stage circuitry 204A. The ramp generator circuitry 302A is discussed further in connection with FIGS. 5 and 6. In some examples, the ramp generator circuitry 302A is instantiated by programmable circuitry executing ramp generator instructions and/or configured to perform operations such as those represented by the flowchart(s) of FIGS. 10 and 11.

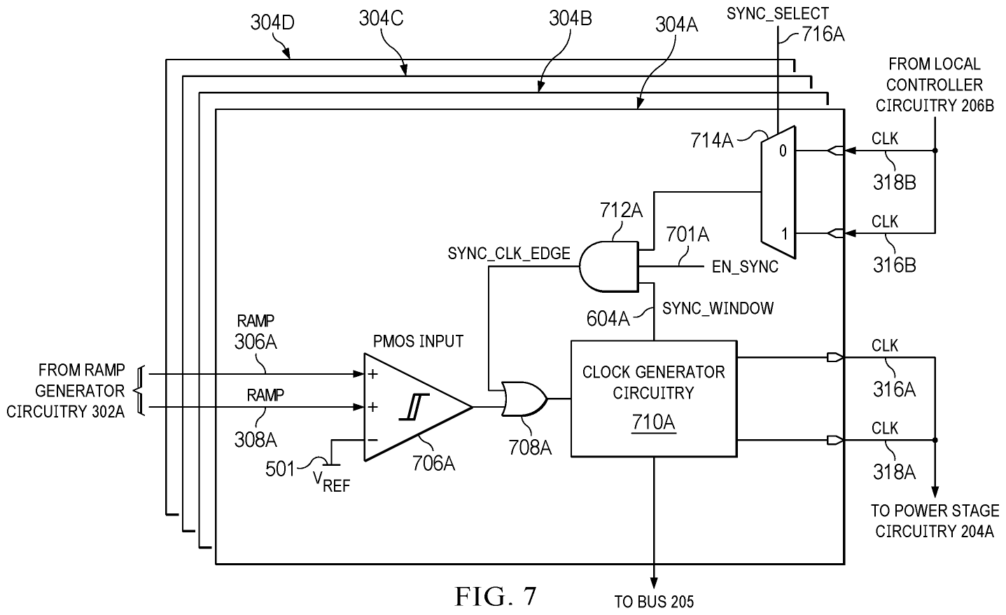

The clock manager circuitry 304A generates pulses (e.g., periods of high voltage) within the clock signals 316A and 318A based on the ramp signal 306A and 308A, respectively. The clock manager circuitry 304A within the local controller circuitry 206A also connects to other local controller circuits 206B, 206C, 206D via the bus 205. In some examples, the clock manager circuitry 304A sends a pulse in the clock signal 316A and/or the clock signal 318A based on instructions from one of the other local controller circuits 206. In other examples, the clock manager circuitry 304A may send instructions to one or more of the other local controller circuits 206 (e.g., local controller circuitry 206B) to cause the other local controller circuitry 206B to send a pulse in the clock signal 316B and/or 318B. The sending and/or receiving of instructions by the clock manager circuitry 304A may generally be referred to as synchronization between the local controller circuits 206. By synchronizing with other local controller circuits 206 and monitoring the ramp signals, the clock manager circuitry 304A both increases the accuracy of the V_OUT signal while correcting errors within the power stage circuitry 204A. The clock manager circuitry 304A is discussed further in connection with FIGS. 7-11. In some examples, the clock manager circuitry 304A is instantiated by programmable circuitry executing clock manager instructions and/or configured to perform operations such as those represented by the flowchart(s) of FIGS. 10 and 11. As used above and herein, a high voltage may refer to a voltage that is interpreted as a logical ‘1’, while a low voltage may refer to a voltage that is interpreted as a logical ‘0’.

The PWM generator circuitry 320A generates pulses in the PWM signals 226A and 228A based on the pulses in the clock signals 316A and 318A, respectively. As used above and herein, a pulse refers to a rectangular waveform in which a signal transitions from a low voltage to a high voltage, remains at the high voltage for a period of time (which defines the width of the pulse), and returns to the low voltage. In examples described herein, the pulses in the clock signals 316A and 318A have fixed widths. When a pulse in a clock signal 316A is generated, it causes the PWM generator circuitry 320A to compare the output of an error amplifier with the ramp signals 306A to generate a pulse in the PWM signal 226A. Notably, the width of pulses in the PWM signals 226A and 228A determines the length at which the power stage circuitry 204A operates in a given stage as discussed further in connection with FIG. 4. As such, the PWM generator circuitry 320A can modulate (e.g., expands or contracts) the width of any pulse in the PWM signals 226A and 228A to achieve a desired behavior within the power stage circuitry 204A. In some examples, the PWM generator circuitry 320A is instantiated by programmable circuitry executing PWM generator instructions and/or configured to perform operations such as those represented by the flowchart(s) of FIGS. 10 and 11.

FIG. 4 is an example block diagram of the power stage circuitry 204A of FIG. 2. The power stage circuitry 204A includes example transistors 402A, 402B, 402C, and 402D (collectively referred to as transistors 402), an example fly capacitor 404 (which may be herein referred to as C_FLY 404), an example switch node 406, and an example inductor 408. Additionally, the voltage provided by the DC power supply unit 106 may be referred to as V_IN, the voltage at the switch node 406 may referred to as V_SW, and the voltage across C_FLY 404 may be referred to as the V_FLY signal 212A.

The transistor 402A includes a first power terminal (e.g., a drain) configured to receive V_IN via the DC power supply unit 106, a control terminal (e.g., a gate) configured to receive the PWM signal 226A, and a second power terminal (e.g., a source) connected to the positive terminal of C_FLY 404. In examples described herein, the transistors 402A is implemented as an n-channel metal oxide semiconductor (NMOS) transistor. In other examples, the transistor 402A may be implemented as a p-channel MOS (PMOS) transistor, a bipolar junction transistor (BJT), or a different transistor architecture.

The transistor 402B includes a first power terminal (e.g., a drain) connected to the positive terminal of C_FLY 404 and to the second power terminal of transistor 402A, a control terminal (e.g., a gate) also configured to receive the PWM signal 228A, and a second power terminal (e.g., a source) connected to the switch node 406. In examples described herein, the transistors 402B is implemented as an n-channel metal oxide semiconductor (NMOS) transistor. In other examples, the transistor 402A may be implemented as a p-channel MOS (PMOS) transistor, a bipolar junction transistor (BJT), or a different transistor architecture.

The transistor 402C includes a first power terminal (e.g., a drain) connected to switch node 406, a control terminal (e.g., a gate) configured to receive the compliment of PWM signal 228A, and a second power terminal (e.g., a source) connected to the negative terminal of C_FLY 404. In examples described herein, the transistors 402C is implemented as an n-channel metal oxide semiconductor (NMOS) transistor. In other examples, the transistor 402A may be implemented as a p-channel MOS (PMOS) transistor, a bipolar junction transistor (BJT), or a different transistor architecture.

The transistor 402D includes a first power terminal (e.g., a drain) connected to the negative terminal of C_FLY 404 and to the second power terminal of transistor 402C, a control terminal (e.g., a gate) also configured to receive the compliment of PWM signal 226A, and a second power terminal (e.g., a source) connected to ground. In examples described herein, the transistors 402D is implemented as an n-channel metal oxide semiconductor (NMOS) transistor. In other examples, the transistor 402A may be implemented as a p-channel MOS (PMOS) transistor, a bipolar junction transistor (BJT), or a different transistor architecture.

Some buck converter architectures operate at two voltage levels by either: a) enabling a high-side power transistor such that V_SW is approximately equal to V_IN, or b) enabling a low-side power transistor such that V_SW is approximately equal to ground. Accordingly, the switch node of such buck converter architectures alternates between V_IN and ground.

The example power stage circuitry 204A supports such voltage levels by using the transistor 402B as the high-side power transistor and transistor 402C as the low-side power transistor. The example power stage circuitry 204A also supports a third voltage level in which V_SW is approximately equal to (V_IN/2). Accordingly, in some examples, the power stage circuitry 204A is referred to as a three-level buck converter.

In some examples, the power stage circuitry 204A alternates between V_IN and (V_IN/2) when a duty cycle of the power stage circuitry 204A is greater than 50%. In other examples, the power stage circuitry 204A alternates between (V_IN/2) and ground when a duty cycle is less than 50%. Such configurability in V_SW enables the power stage circuitry 204A to support a wider variety of power requirements from the load 110 with lower output current ripple and increased power density than buck converts that only support two voltage levels at V_SW.

To support the stage of operation where V_SW≈(V_IN/2), the power stage circuitry 204A includes transistors 402B, 402D, and the C_FLY 404. Suppose, for example, the power stage circuitry 204A is operating in an environment where V_SW is to alternate between (V_IN/2) and ground. To implement such behavior in the power stage circuitry 204A, the local controller circuitry 206A disables transistors 402A and 402C and enables transistors 402B and 402D during a first stage. Additionally, C_FLY 404 is connected to the switch node 406 during the first stage. As a result, C_FLY 404 discharges into the switch node 406 (thereby establishing V_SW=V_FLY≈(V_IN/2)). The voltage at the switch node 406 also energizes the inductor 408 and increases the current provided to the load 110.

As used above and herein, enabling one of the transistors 402 may refer to providing a high voltage in the appropriate PWM signal 226A or 228A, thereby providing the high voltage to the control terminal and allowing current to flow through the transistor. Because the PWM signal 226A and 228A are transmitted as pulses, the width of the pulse determines the length of time that the transistor is enabled (and therefore, the length of time that the power stage circuitry 204A operates in a given stage).

Once the current flowing through the inductor 408 reaches a first threshold amperage, the local controller circuitry 206A transitions to a second stage by both disabling the transistor 402B and enabling the transistor 402C. As a result, transistors 402A and 402B are disabled and transistors 402C and 402D are enabled during the second stage. Additionally, the switch node 406 is tied to ground (e.g., V_SW≈0 V), C_FLY 404 is disconnected, the inductor 408 is de-energized, and current provided to the load 110 decreases during the second stage.

After the current flowing through the inductor 408 decreases to a second threshold amperage, the local controller circuitry 206A enables transistors 402A and 402C and disables the transistors 402B and 402D in a third stage. In this third stage, current from V_IN charges C_FLY 404, energizes the inductor 408, and is provided to the load 110. While in the first stage, the voltage at V_SW=V_IN−V_FLY≈(V_IN/2).

After the current flowing through the inductor 408 reaches the first threshold amperage again, the local controller circuitry 206A transitions to a fourth stage. The fourth stage is functionally equivalent to the second stage as described above. That is, the transistors 402A and 402B are disabled and transistors 402C and 402D are enabled, the switch node 406 is tied to ground (e.g., V_SW≈0 V), and C_FLY 404 is disconnected. As a result, the inductor 408 is de-energized in preparation for another cycle.

As used above and herein, a cycle may refer to a continuous period of time in which the local controller circuitry 206A enables and disables the transistors 402 to alternate the value of V_SW between two of the three supported voltage levels (e.g., V_IN, (V_IN/2), and ground). In the foregoing example, a cycle in which V_SW alternates between (V_IN/2) and ground is implemented by the local controller circuitry 206A discharging C_FLY 404 in the first stage, disconnecting C_FLY in the second stage, charging C_FLY 404 in the third stage, and then disconnecting C_FLY again in the fourth stage. In other examples, the local controller circuitry 206A enables and disables the transistors 402 in a different sequence and/or implements a cycle where V_SW alternates between two different voltages (e.g., V_IN and (V_IN/2)). In some examples, the stages that form a cycle of the power stage circuitry 204A may be referred to as periods. In such examples, the first stage may be referred to as a discharge period, the second stage may be referred to as first disconnection period, the third stage may be referred to as a charge period, and the fourth stage may be referred to as a second disconnection period.

Ideally, the local controller circuitry 206A implements the example cycle discussed above such that any charge removed from C_FLY 404 during the first stage is subsequently added back to C_FLY 404 during the third stage. If there is a net difference in the amount of charge stored in C_FLY 404 after a cycle, then the value of V_FLY would change over the course of multiple cycles and the accuracy of the output provided by the power stage circuitry 204A would decrease.

In some examples, the power stage circuitry 204A exhibits an error that causes a net difference in the amount of charge after a cycle. Such an error may be referred to herein as a V_FLY error, because the error causes V_FLY≠(V_IN/2). The error within the power stage circuitry 204A may occur for any reason, including but not limited to slight differences in the timing of charge and discharge modes of operation in the three-level converter.

U.S. patent application Ser. No. 15/858,626 describes techniques to control the power stage circuitry 204A such that the value of V_FLY remains equal to V_IN/2 across multiple cycles, thereby correcting for the error exhibited in the power stage circuitry 204A. U.S. patent application Ser. No. 15/858,626 is hereby incorporated by reference in its entirety. In some examples, the techniques described in U.S. patent application Ser. No. 15/858,626 may be referred to as harmonic modulation. Harmonic modulation is discussed further in connection with FIG. 5.

FIG. 5 is an example timing diagram of signals produced by the local controller circuitry 206A and power stage circuitry 204A of FIG. 2. In particular, FIG. 5 illustrates how the local controller circuitry 206A can use harmonic modulation techniques to correct V_FLY error within the power stage circuitry 204A. FIG. 5 includes pulses from the clock signals 316A, 318A, and the V_FLY signal 212A of FIG. 2. FIG. 5 also includes an example reference voltage 501 (which may be referred to herein as V_REF 501) and example ramp signals 502, 504, 506, and 508.

Suppose an error in the power stage circuitry 204A occurs such that, at the end of the cycle, V_FLY>(V_IN/2). In such an example, the power stage circuitry 204A may seek to implement the next cycle of power stage circuitry 204A with a net decrease to the charge on C_FLY 404. The net decrease in charge of the subsequent cycle would counteract the V_FLY error, thus re-establishing V_FLY=(V_IN/2) and increasing the accuracy of the output provided to the load.

FIG. 5 illustrates operations in the subsequent cycle (e.g., a net decrease to the charge on C_FLY 404) of the foregoing example. That is, the timing diagram of FIG. 5 is divided into a first, second, third, and fourth stage for the power stage circuitry 204A with pre-existing error such that V_FLY>(V_IN/2). Accordingly, the labels of first stage, second stage, third stage, and fourth stage correspond to the ramp signals 504 and 508 (which illustrate the ramp signals 306A and 308A, respectively, when the power stage circuitry 204A has V_FLY error). During the stages, the power stage circuitry 204A operates as described above in connection with FIG. 4. Notably, the local controller circuitry 206A changes the states of the transistors 402 such that the first stage (where C_FLY 404 discharges) is longer than the third stage (where C_FLY 404 charges) to achieve the net decrease in charge.

In FIG. 5, the change in stage lengths that the local controller circuitry 206A makes to correct the V_FLY error is referred to as δT. Accordingly, the length of the first stage is (T3 T1)=D₁₈₀(T_SW/2+δT), and the length of the third stage is (T6−T5)=D₀(T_SW/2−δT). As used above and herein, D(T_SW/2) refers to the length of the first stage and the third stage had there been no V_FLY error.

A cycle of the power stage circuitry 204A can be subdivided into two half-cycles, where the first stage and the second stage are a first half cycle and the third stage, and the fourth stage are a second half cycle. The local controller circuitry 206A strives to keep the duty cycle of the first half cycle (e.g., the length of the first stage divided by the length of the first half-cycle) equal to the duty cycle of the second half-cycle (e.g., the length of the third stage divided by the length of the second half-cycle).

To maintain equal duty cycles between the first half-cycle and second half-cycle, the power stage circuitry 204A should operate such that the ratio between the lengths of the first stage and the second stage is equal to the ratio between the lengths of third stage and the fourth stage. If the power stage circuitry 204A operates in a manner such that the duty cycle of the first half-cycle is unequal to the second half-cycle, the inductor current changes across the half cycle and the efficiency of the power stage circuitry 204A decreases.

When implementing harmonic modulation techniques, the local controller circuitry 206A expands or contracts both stages within a half-cycle to maintain a desired duty cycle. For example, in FIG. 5, the duty cycle of both the first half-cycle and second half-cycle was 50% in a previous cycle that did not have V_FLY error (as shown by the ramp signals 502 and 506). In response to the occurrence of an error such that V_FLY>(V_IN/2), the local controller circuitry 206A: a) increases the length of the first stage to lengthen the discharge period of C_FLY 404, and b) also increases the length of the second stage, relative to a cycle with no V_FLY error, by δT(1−D)/D such that the length of the first stage divided by the length of the first half-cycle remains at 50%. Similarly, the local controller circuitry 206A also decreases the length of the fourth stage, relative to a cycle with no V_FLY error, by δT(1−D)/D in response to a decrease in length of the third stage. While the change in length of the second and fourth stages do not affect the value of V_FLY (because C_FLY 404 is disconnected from the switch node 406 during such periods), the changes do maintain while the duty cycle of both half-cycles while also allowing the half-cycles to be different lengths (thereby correcting the V_FLY error that was previously exhibited). In examples where the power requirements of the load 110 call for a different duty cycle, the local controller circuitry 206A may change the lengths of the stages by different amounts.

In general, the ramp generator circuitry 302A implements harmonic modulation by changing the slope of the ramp signals 306A and 308A based on the V_FLY signal 212A and a threshold value (labelled in FIG. 5 as V_REF 501). In some examples, the value of V_REF 501 is set by a current source, a resistor, and a capacitor within or connected to the clock manager circuitry 304A.

The ramp signal 504 shows that, when the ramp signal 306A reaches V_REF 501 at T5, the clock manager circuitry 304A generates a pulse in the clock signal 318A which enables and/or disables one or more transistors 402 such that the power stage circuitry 204A operates in the third stage. The ramp signal 306A reaching the threshold value also causes the ramp signal 306A to reset to a low voltage. The ramp signal 306A reaching the threshold value of V_REF 501 at T5 also causes the clock manager circuitry 304A to begin monitoring ramp signal 308A so that a pulse can later be fired in the clock signal 316A. Accordingly, when the ramp signal 508 (e.g., the ramp signal 308A with error) reaches V_REF 501 at T7, the clock manager circuitry 304A generates a pulse in the clock signal 316A, which enables and/or disables one or more transistors 402 such that the power stage circuitry 204A operates in the first stage of a subsequent cycle. The ramp signal 308A reaching the V_REF 501 also causes: a) the ramp signal 306A to reset to the low voltage, and b) the clock manager circuitry 304A to resume monitoring the ramp signal 306A.

In the example of FIG. 5, ramp signals 502 and 506 represent how the ramp signals 306A and 308A would be generated without any V_FLY error, while ramp signals 504 and 508 represent how the ramp signals 306A and 308A would be generated in response to V_FLY>(V_IN/2). Ramp signal 502 shows that, without V_FLY error, the ramp signal 306A would reach V_REF 501, a pulse would be generated in the clock signal 318A, and the second half-cycle would begin, at T4. When V_FLY>(V_IN/2), the ramp signal 504 shows that the ramp generator circuitry 302A generates the ramp signals 306A with a shallower slope than it otherwise would have (e.g., ramp signal 504 has a shallower slope than ramp signal 502). As a result, the first half cycle lasts longer than it would without V_FLY error, and C_FLY 404 discharges more than it would without V_FLY error. Similarly, the ramp signal 508 is steeper than ramp signal 506 such that the second half cycle lasts shorter than it would without V_FLY error, and C_FLY 404 charges less than it would without V_FLY error. As a result, the V_FLY signal 212A in FIG. 5 is closer to (V_IN/2) at T7, when the error correction cycle ends, than it was at T1 when the error correction cycle began. In some examples, the local controller circuitry 206A may implement multiple sequential error correction cycles to proportionally decrease or increase the value of V_FLY over time.

Harmonic modulation enables the correction of V_FLY error while maintaining balanced duty cycles within the power controller circuitry 206A as discussed above. However, the foregoing technique increases the total length of a cycle whenever a V_FLY error occurs. For example, using arbitrary values for simplicity, suppose ramps 502 and 506 both have a slope of 1 Volts per microsecond (V/μs) and that V_REF 501=1 V. Accordingly, both half-cycles would take 1 microsecond to complete without V_FLY error, and T8−T2 (the total length of a cycle without error) would equal 2.0 μs. Suppose further that, to correct for V_FLY>(V_IN/2), the ramp generator circuitry 302A decreased the slope of ramp signal 504 to 0.5 V/μs and increased the slope of ramp signal 508 to 2 V/μs. In such an example, the ramp signal 504 requires signal 2.0 μs to reach the threshold of 1 V (so the first half-cycle lasts for 2.0 μs), the ramp signal 506 requires 0.5 μs to reach the threshold voltage (so the second half-cycle lasts for 0.5 μs), and the total length of the cycle (e.g., the length of T7−T1) is 2.5 μs. More generally, V_FLY error correction using harmonic modulation alone may increase the total length of a cycle (compared to the length of corresponding periods in a cycle without error), regardless of whether the error correction cycle is applying a net increase or decrease to the charge in C_FLY 404. Furthermore, because the amount of V_FLY error is specific to an individual power stage circuit 204A and can change between clock cycles, harmonic modulation techniques alone may result in the expansion of any cycle by any amount of time. Accordingly, other buck converter circuits that enable harmonic modulation techniques are unable to synchronize the output of multiple buck converters because the length of the cycles are unpredictable.

Example methods, apparatus, and systems herein implement local controller circuits that can both correct for local V_FLY error using harmonic modulation and synchronize with the output of multiple power stage circuits on a global level. That is, although any of the power stage circuits 204A may exhibit a V_FLY error that is different in magnitude and independent from the V_FLY error of the other power stage circuits 204B 204C, 204D, the example local controller circuitry 206A can communicate with the other local controller circuits 206 such that the outputs of the both power stage circuitry 204A both corrects the V_FLY error and is synchronized with the outputs of the power stage circuits 204. To do so, the clock manager circuitry 304A in local controller circuitry 206A communicates with the other clock manager circuitry 304A instances such that pulses in one of the clock signals (e.g., a synchronization pulse) occur at approximately the same time globally, while a pulse in the other clock signal (e.g., a harmonic modulation pulse) is positioned based on the synchronization pulse to correct for local V_FLY error.

FIG. 6 is an example of a timing diagram including signals produced by the ramp generator circuitry and clock manager circuitry of FIG. 3. FIG. 6 includes the ramp signals 306A, 308A, 306B, 308B of FIG. 3, the clock signals 316A, 318A, 316B, 318B of FIG. 3, and V_REF 501 of FIG. 5. FIG. 6 also includes example sync window signals 604A and 604B and time stamps that are independent of (e.g., may refer to different points in time than) the time stamps of FIG. 5.

The ramp signals 306A and 308A are generated by the ramp generator circuitry 302A and describe the length of the first half-cycle and the second half-cycle, respectively, for the power stage circuitry 204A. Similarly, the ramp signals 306B and 308B are generated by the ramp generator circuitry 302B and describe the length of the first half-cycle and the second half-cycle, respectively, for the power stage circuitry 204B. The example of FIG. 6 describes a period of time where the power stage circuitry 204A does not have V_FLY error, while the power stage circuitry 204B has positive V_FLY error such that V_FLY>(V_IN/2).

If the local controller circuitry 206A and 206B were to operate independently from one another, both controllers would cause their respective power stage circuits 204A and 204B to transition between half-cycles when the appropriate ramp signal reaches a threshold value, referred to in FIG. 6 as V_REF 501. In examples described herein, V_REF 501 refers to a voltage at approximately the midpoint between the maximum and minimum voltages exhibited on the ramp signals 306 and 308 (as shown in FIG. 6). In some examples, the value of V_REF 501 is proportional to the value of V_IN provided by the DC power supply unit 106. In the example of FIG. 6, the local controller circuitry 206A and 206B communicate with one another in accordance with the teachings described herein. As a result, one or more clock pulses may fire before the corresponding ramp signal passes V_REF 501 as discussed further below.

When the C_FLY 404 voltage has no error, as the power stage circuitry 204A has in the example of FIG. 6, the slopes of the ramp signals 306A and 308A are equal. Furthermore, when the ramp signal 308A reaches V_REF 501 at T2, the ramp signal 306A is at or near a peak voltage because the ramp signals 306A and 308A are at or near 180 degrees out of phase (with variations in the magnitude of phase shift occurring due to harmonic modulation). Accordingly, the clock manager circuitry 304A fires a pulse in the clock signal 316A, thereby causing the first half-cycle to end, at T2. Similarly, the ramp signal 306A reaching V_REF 501 causes the clock manager circuitry 304A to fire a pulse in the clock signal 318A, thereby causing the second half-cycle to end, at T6.

In the power stage circuitry 204B of FIG. 5, CFLY 404 has a higher than ideal voltage. To correct for this error, devices using harmonic modulation alone would reduce the slope of ramp signal 308B (relative to ramp signal 306A) to increase the discharge time and would increase the slope of ramp signal 306B (relative to ramp signal 308A) to reduce the charge time. Using such a technique, the first half-cycle of power stage circuitry 204B would end at T3 and the second half-cycle would end at T5. Accordingly, if the power stage circuitry 204A and 204B were controlled by devices using harmonic modulation alone, none of the clock pulses in clock signals 316A, 318A, 318B, and 318B would occur at the same time and global synchronization would not be achieved.

In the example of FIG. 6, the ramp generator circuitry 302A and 302B independently start the ramp signals 308A and 306B at the same time but with different slopes to account for the differences in V_FLY error. Then, the ramp signal 308A crossing V_REF 501 at T2 causes the clock manager circuitry 304A to send a message to the clock manager circuitry 304B in accordance with the teachings described herein. The message causes the clock manager circuitry 304B to fire the pulse in the clock signal 318B earlier than it would have (e.g., before a threshold amount of time has passed) at T2 rather than T3. The firing of the pulse in the clock signal 318B ends the first half-cycles of both power stage circuits 204A, 204B at approximately the same time (e.g., T2) and achieves global synchronization.

Because the clock manager circuitry 304B was forced to fire the pulse in clock signal 318B at T2 rather than T3, the desired increase in discharge time to correct for V_FLY>(V_IN/2) is not fully realized. As a result, the clock manager circuitry 304 fires a pulse in the clock signal 316B at T4, earlier than it would have if harmonic modulation only was used for V_FLY error (e.g., at T5) or if there was no V_FLY error (e.g., at T6). The earlier firing of a pulse at T4 decreases the length of third period where C_FLY 404 charges. The clock manager circuitry 304B determines the precise timing of the pulse in clock signal 316B based on the decrease in length of the first period where C_FLY 404 discharges. Accordingly, the power stage circuitry 304B still exhibits a longer discharge period (e.g., between T1 and T2) than a charge period (e.g., between T2 and T4), so V_FLY>(V_IN/2) can be corrected.

In the example of FIG. 6, the clock manager circuitry 304A sends a message to the clock manager circuitry 304B at T2 because the power stage circuitry 204A had no V_FLY error while the power stage circuitry 304B had V_FLY error, thereby causing ramp signal 308A to reach V_REF 501 before ramp signal 306B. More generally, for any n power stages synchronized together according to the teachings described herein, the power stage circuitry with the least error will cause its local controller to send a message to the other local controllers. Notably, because the amount of V_FLY error can change at any cycle, the local controller that sends a message to the other controllers can also change at any cycle. Therefore, the local controller circuits 206 do not include a primary role or secondary role. Instead, the local controller circuits 206 send and receive messages on a cycle-by-cycle basis to collectively synchronize.

The sync window signal 604A refers to a rectangular waveform that describes when the local controller circuitry 206A is ready to synchronize. When the sync window signal 604A is at a high voltage, the local controller circuitry 206A is prepared to either send or receive a message to or from the other local controller circuits 206 such that pulses in clock signals 316A and 318B are fired at the same time globally. The clock signals 316A and 318B are synchronized with one another in examples herein so that the power stages are out of phase with one another when synchronized. By being out of phase during synchronization, the power stage circuitry 204A can decrease power on its output terminal connected to the load 110 while the power stage circuitry 204B increases power on its output terminal connected to the load 110 (or vice versa). Such a configuration allows the controller circuitry 202 as a whole to reduce the magnitude of ripple that occurs in the V_OUT voltage provided to the load 110, thereby improving performance of the multi-phase buck regulator circuitry 108.

When the sync window signal 604A is at a low voltage, the local controller circuitry 206A is waiting to fire a pulse in the clock signal 318A at a specific time to achieve harmonic modulation and correct any potential V_FLY error in the power stage circuitry 204A. Accordingly, the sync window signal 604A transitions to a low voltage at T2 and transitions back to a high voltage at T6.

The sync window signal 604B refers to when the local controller circuitry 206B is ready to synchronize and operates as described above. Notably, the power stage circuitry 204B can have a different amount of V_FLY error than the power stage circuitry 204A, so the sync window signal 604B may transition between high and low voltages at different times than the sync window signal 604A. For example, the error correction cycle ends and the sync window signal 604B transitions to a high voltage at T4, while the sync window signal 604A does not transition to a high voltage until T6. As a result, when synchronizing n different power stage circuits, the local controller circuits 206 collectively wait until each of the n different sync window signals 604 are at a high voltage before sending or receiving messages from one another. As used herein, a synchronization window may refer to the period when each of n different local controller circuits 204 participating in synchronization have high voltages within the sync window signals 604.

In the example of FIG. 6, the local controller circuitry 206A and 206B implement the foregoing technique such that a next set of global synchronous pulses in the clock signals 316A and 318B cannot occur until after T6. Based on the amount of V_FLY error present in the power stage circuitry 204A and 204B, the firing of the next set of global synchronous pulses in the clock signals 316A and 318B occurs at T7.

FIG. 7 is a first example block diagram of the clock manager circuitry 304A of FIG. 3. The clock manager circuitry 304A includes the ramp signals 306A and 308A of FIG. 3, V_REF 501, and sync window signal 604A of FIG. 6. The clock manager circuitry 304A also includes an example engage sync signal 701A (which may be herein referred to as EN_SYNC signal 701A), example comparator circuitry 706A, an example OR gate 708A, example clock generator circuitry 710A, an example AND gate 712A, an example multiplexer 714A, and an example SYNC_SELECT signal 716A.

FIG. 7 also includes the clock manager circuits 304B, 304C, 304D, which each include a local instance of the foregoing components. That is, the clock manager circuitry 304B includes an example EN_SYNC signal 701B, example comparator circuitry 706B, an example OR gate 708B, example clock generator circuitry 710B, example AND gate 712B, an example multiplexer 714B, an example SYNC_SELECT signal 716B, etc. Furthermore, components within the clock manager circuitry 304B, 304C, 304D may operate according to the teachings described herein and discussed below in reference to clock manager circuitry 304A.

The EN_SYNC signal 701A is a binary signal (e.g., set to either a high voltage or a low voltage) that describes whether the local controller circuitry 206A is currently engaged in synchronization. In the example of FIG. 6, the EN_SYNC signal 701A and 701B are at a high voltage, while the EN_SYNC signals 701C and 701D are at a low voltage. Accordingly, the local controller circuits 206A and 206B synchronize clock signals with one another, and the local controller circuits 206C and 206D to not engage in synchronization. More generally, while examples described herein refer to synchronization between two local controller circuits 206A and 206B, the teachings described herein may apply to any number of controller circuits.

The value of the EN_SYNC signals 701A-701D are set by programmable circuitry that is within the controller circuitry 202 of FIG. 2. but external to the local controller circuits 206. The programmable circuitry provides the EN_SYNC signals 701A-701D to the respective local controller circuits via the bus 205. The programmable circuitry may choose to enable or disable synchronization using the EN_SYNC signals 701A-701D. In some examples, an EN_SYNC signal 701C is at a low voltage because the corresponding power stage circuitry 204C is powered off. Operating the multi-phase buck regulator circuitry 108 with some but not all of the power stage circuits 204 powered on may be referred to as phase shedding.

During a first half-cycle, the comparator circuitry 706A compares the ramp signal 306A to V_REF 501. If the value of the ramp signal 306A meets (e.g., reaches) or exceeds the value V_REF 501 during the first half-cycle, the comparator circuitry 706A outputs a pulse (e.g., a high voltage for a period of time). During the rest of the first half-cycle, the comparator circuitry 706A outputs a low voltage. Similarly, during the second half-cycle, the comparator circuitry 706A compares the ramp signal 308A to V_REF 501. If the value of the ramp signal 308A meets, reaches, or exceeds the value V_REF 501 during the second half-cycle, the comparator circuitry 706A outputs a pulse. During the rest of the second half-cycle, the comparator circuitry 706A outputs a low voltage.

The OR gate 708A receives a first input from the comparator circuitry 706A and a second input from the AND gate 712A. The AND gate 712A, in turn, receives the sync window signal 604A as a first input, the EN_SYNC signal 701A as a second input, and the output of the multiplexer 714A as a third input. As used herein, a first component that receives a signal may refer to the first component being connected to (e.g., coupled to) a second component (e.g., a copper trace, a wire, a pin, a terminal, etc.) that carries the signal.

The multiplexer 714A provides a message from the local controller circuitry 206B. The value of the message is based on the SYNC_SELECT signal 716A. In examples described herein, the clock signals 316A and 318B are globally synchronized. As such, SYNC_SELCT=0 and the message received at the AND gate 712A are pulses from the clock signal 318B. More generally, any arbitrary index of clock signals may be synchronized and shared over the bus 205 provided that the local controller circuits 206 participating in synchronization each use one clock signal used for global synchronization (e.g., fires pulses based on the timing of the other controllers) and one clock signal used for harmonic modulation (e.g., fires pulses independently of the other controllers). The values of the SYNC_SELECT signal 716A-716D, which may be set by programmable circuitry external to the local controller circuits 206, selects which clock signals will be used for synchronization. In some examples, the clock signal 316B may be referred to as an external clock signal because it is generated externally from the local controller circuitry 206A.

As discussed above, the sync window signal 604A is at a high value when the local controller circuitry 206A is ready to synchronize pulses in the clock signal 316A (e.g., is not waiting to fire a pulse in the clock signal 318A using harmonic modulation techniques). Similarly, the local controller circuitry 206B only sends a pulse in the clock signal 318B when the sync window signal 604B is at a high voltage and the ramp signal 306B crosses V_REF 501. Therefore, the output of the AND gate 712A (which may be referred to herein as the SYNC_CLK_EDGE signal) only transitions to a high voltage when the ramp signal 306B crosses V_REF 501 and both the local controller circuits 206A, 206B are ready to synchronize.

During the first half-cycle, the sync window signal 604A is at a high voltage as discussed above. Accordingly, the OR gate 708A may receive a high voltage from one or both input terminals during the first half-cycle. During a synchronization window, if the power stage circuitry 204A has less V_FLY error than the power stage circuitry 204B, than the output of the comparator circuitry 706A transitions to a high voltage before the SYNC_CLK_EDGE signal because the difference in V_FLY error caused the ramp signal 308A to reach V_REF 501 before the ramp signal 306B (as shown at T2 in FIG. 6). In such an example, the output of the OR gate transitioning to a high voltage causes the clock generator circuitry 710A to fire a pulse in the clock signal 316A. The pulse is received by both: a) the PWM generator circuitry 320A, thereby causing a pulse to be fired in the PWM signal 226A, and b) the local controller circuitry 206B via the bus, thereby causing a pulse to be fired in the clock signal 318B.

Alternatively, if the power stage circuitry 204A has more V_FLY error than power stage circuitry 204B during a synchronization window, then the SYNC_CLK_EDGE signal transitions to a high voltage before the output of the comparator circuitry 706A because the difference in V_FLY error caused the ramp signal 306B to reach V_REF 501 before the ramp signal 308A. In such an example, the output of the OR gate transitioning to a high causes the clock generator circuitry 710A to fire a pulse in the clock signal 316A. The pulse is received by both: a) the PWM generator circuitry 320A, thereby causing a pulse to be fired in the PWM signal 226A, and b) the local controller circuitry 206B via the bus 205. However, in such an example, the local controller circuitry 206B does not fire a pulse in the clock signal 316B in response to the pulse in clock signal 316A because the power stage circuitry 204B having less V_FLY error means that the pulse in the clock signal 316B was already transmitted.

Accordingly, the local controller circuitry 206B is already in the second half-cycle and no longer needs to synchronize. Furthermore, the sync window signal 604B is at a low voltage when the pulse in clock signal 316A is received at the AND gate 712B and the pulse from the clock signal 316A is ignored.

During the second half-cycle, the synchronization window is closed and the SYNC_CLK_EDGE signal in both clock manager circuits 304A and 304B remains at a low voltage. Accordingly, the OR gate 708A only transitions to a high voltage during the second half-cycle once the ramp signal 306A reaches V_REF 501. Notably, the ramp generator circuitry 302A receives the V_FLY signal 212A and therefore observes the change that occurs to the charge of C_FLY 404 during the first half-cycle. The ramp generator circuitry 302A then adjusts the slope of the ramp signal 306A, if necessary, to account for any current V_FLY error (which may be greater than anticipated if the local controller circuitry 206B caused the clock generator circuitry 710A to fire a pulse in the clock signal 316A before the ramp signal 308A reached V_REF 501). The ramp generator circuitry 710A, in turn, fires a pulse in the clock signal 318A at a different time due to the adjusted slope of ramp signal 306A. Accordingly, the local controller circuitry 206A synchronizes with the local controller circuitry 206B and still implements harmonic modulation by firing a pulse in the clock signal 318A based on the timing of the pulse in clock signal 316A.

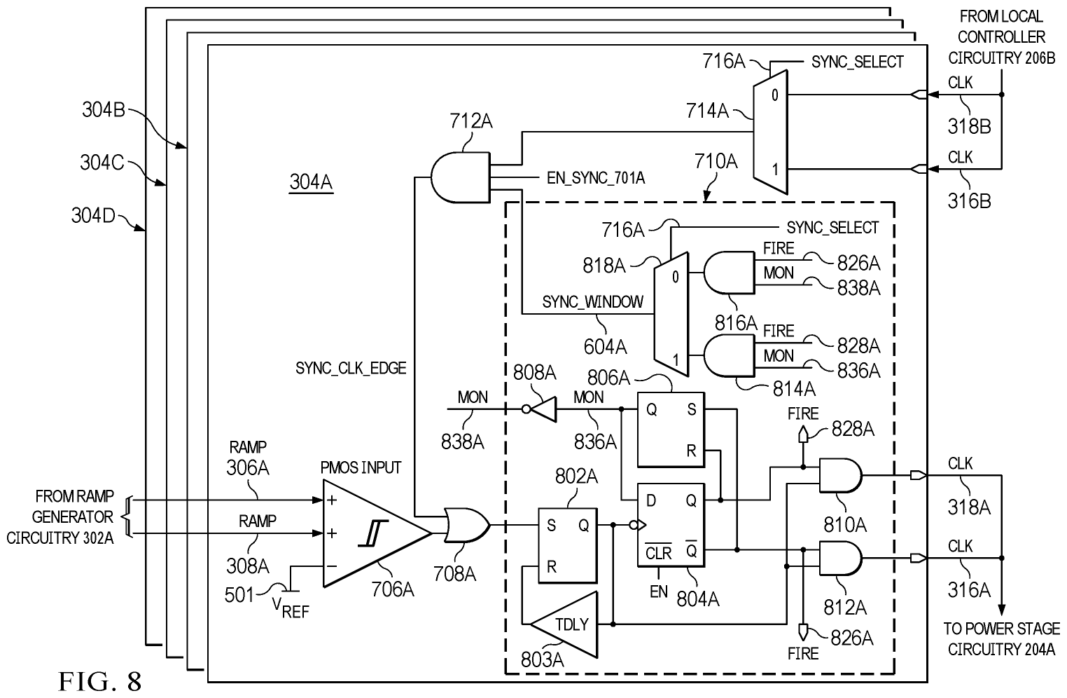

The clock generator circuitry 710A generates pulses in the clock signals 316A and 318A based on a logical ‘1’ received from the OR gate 708A. The clock generator circuitry 710A may be implemented by any form of programmable circuitry. An example implementation of the clock generator circuitry 710A is discussed further in connection with FIG. 8.

FIG. 8 is a second example block diagram of the clock manager circuitry of FIG. 3. The example clock manager circuitry 304A of FIG. 8 includes the same components, signals, and connections described above in connection with FIG. 7. FIG. 8 also shows that the clock generator circuitry 710A includes example RS flip-flop circuitry 802A and 806A, example time delay circuitry 803A, example D flip-flop circuitry 804A, an example inverter 808A, example AND gates 810A, 812A, 814A, 816A, and an example multiplexer 818A. The clock generator circuitry 710A further includes example fire signals 826A, 828A, example monitor signals 836A, 838A, and the SYNC_SELECT signal 716A.

RS flip-flop circuitry 802A has an S terminal connected to the output of the OR gate 708A. When the OR gate 708A transitions to a high voltage state (e.g., when a pulse in one of the clock signals 316A or 318A should be fired for either synchronization or harmonic modulation), the Q terminal of the RS flip-flop circuitry 802A outputs the same high state until the time delay circuitry 803A resets the RS flip-flop circuitry 802A. The time delay circuitry provides a high voltage to the R terminal of the RS flip-flop circuitry 802A, thereby resetting the circuit, after a pre-determined amount of time (e.g., a few nanoseconds). As such, the period before the time delay circuitry 803A resets the RS flip-flop circuitry 802A defines the pulse-width of the clock signals 316A and 318A.

The monitor signals 836A and 838A are both digital signals that describe whether the ramp signal 306A and ramp signal 308A, respectively, have crossed V_REF 501 at any point in time. In some examples, the clock manager circuitry 304A includes a first comparator circuit to compare ramp signal 306A to V_REF 501 and a second comparator circuit to compare ramp signal 308A to V_REF 501 (as opposed to the single comparator circuitry 706A described in FIGS. 6, 7 that performs both comparisons). In such examples with two comparators, the clock generator circuitry 710A may be implemented without monitor signals 836A and 838A because the outputs of the comparator circuits would provide the same voltages.

The Q and Q-not terminals of D-flip flop circuitry 804A produce the fire signals 828A and 826A, respectively. The fire signals 826A and 828A indicate when a pulse in the clock signal 318A and the clock signal 316A should fire (e.g., when the clock generator circuitry 710 should generate a rectangular pulse within the clock signal 318A and 316A). The AND gate 810A receives the fire signal 828A at a first terminal and the output of the RS-flip flop circuitry 802A at a second terminal. Similarly, The AND gate 812A receives the fire signal 826A at a first terminal and the output of the RS flip-flop circuitry 802A at a second terminal. Therefore, one input of both AND gates 810A or 812A reach a high voltage whenever a ramp signal reaches V_REF 501. However, because the Q and Q-not terminals are inverse, only one of the fire signals 828A and 868A is at a high voltage at any time. As such, a pulse is fired in only one of the clock signals 316A, 318A when a ramp signal reaches V_REF 501. The D-flip flop circuitry 804A keeps track of which ramp signal last reached V_REF 501 and sets the voltages of the Q and Q-not terminals such that the pulse fires in the corresponding clock signal at the next occurrence of a ramp signal reaching V_REF 501.

The clock generator circuitry 710A is also connected to the bus 205 such that, if the ramp signal 308A reaches V_REF 501 before the ramp signal 306B during a synchronization window, the clock generator circuitry 710A can provide one of the clock signals 318A or 316A to the local controller circuitry 206B based on the value of the SYNC_SELECT signal 716A. In the example of FIG. 7, SYNC_SELECT=0 and the clock generator circuitry 710A sends the clock signal 316A once it has been fired. In some examples, the pulse in clock signal 316A an instruction, a message, etc.

The RS flip-flop circuitry 806A and the inverter 808A collectively generate the monitor signals 836A and 838A. At any point in time, the Q terminal of the RS flip-flop circuitry 806A outputs the monitor signal 836A. The output of the Q terminal is both: a) provided to the appropriate AND gate 816A, and b) provided to the inverter 808A to generate the monitor signal 838A. Like the ramp signals 306A and 308A they describe, the monitor signals 836A and 838A may be considered inverses of one another because they have opposite values. For example, if ramp signal 306A reaches V_REF 501, then the ramp signal 308A has not yet reached V_REF 501 so the monitor signal 838A is at a high voltage to allow ramp 308A to be used by the comparator. Accordingly, at any point in time, both the monitor signals 836A and 838A are present for use by the comparator 706A, and AND gates 816A, 814A respectively.

The example multiplexer 818A generates the sync window signal 604A based on inputs from the SYNC_SELECT signal 716A and the AND gates 814A, 816A. The AND gate 814A receives the fire signal 828A at a first input terminal and the monitor signal 838A at a second input terminal. Similarly, the AND gate 816A receives the fire signal 826A at a first input terminal and the monitor signal 836A at a second input terminal.

As shown in FIG. 6, the SYNC_WINDOW signal 604A indicates when the power stage circuitry 204A has completed a second half-cycle (and the local controller circuitry 206A is therefore ready to synchronize in the subsequent cycle). In examples described herein, SYNC_SELECT=0, and the local controller circuits 206 synchronize the clock signals 316A and 318B based on the ramp signals 308A and 306B. Accordingly, the output of the AND gate 816A is at a high voltage after a second half-cycle ends. The clock generator circuitry 710A determines the second half-cycle has ended when the fire signal 826A is at a high voltage, indicating the clock signal 316A will fire a pulse next, and when the monitor signal 838A is at a high voltage, indicating the ramp signal 308A will cross V_REF 501 next.

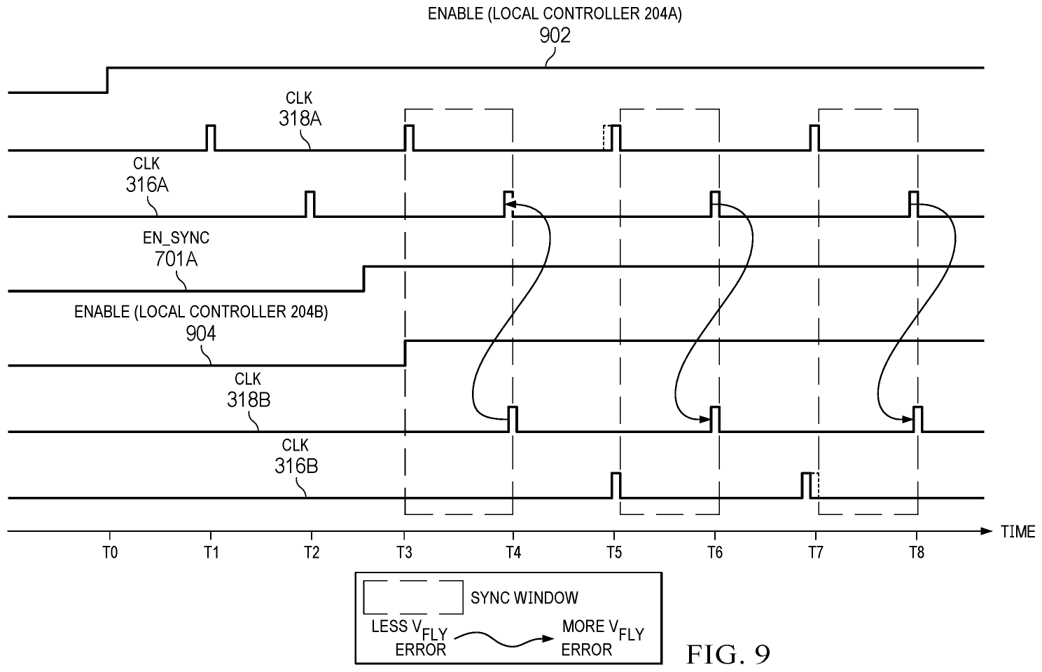

FIG. 9 is an example timing diagram of signals produced by the clock manager circuitry of FIGS. 7 and 8. FIG. 9 includes the clock signals 316A, 318A, 316B, 318B of FIG. 3, and the EN_SYNC signal 701A of FIG. 7. FIG. 9 also includes example enable signals 902, 904, and time stamps that are independent of (e.g., may refer to different points in time than) the time stamps discussed above.

The example enable signals 902 and 904 are binary signals that describes the functionality of the local controller circuitry 206A and 206B, respectively. For example, when the enable signal 902 is at a high voltage, the local controller circuitry 206A is generating pulses in the clock signals 316A, 318A, sending pulses in the PWM signals 226A, 228A, and causing the power stage circuitry 204A to provide a voltage to the load 110. When the enable signal 902 is at a low voltage, the local controller circuitry 206A is not generating pulses and the power stage circuitry 204A is not contributing to the load 110. Similarly, a high voltage indicates the enable signal 904 indicates the local controller circuitry 206B is generating pulses and a low voltage indicates the local controller circuitry 206B is not generating pulses. Programmable circuitry that is within the controller circuitry 202 and external to the local controller circuits may set the value of the enable signals 902, 904 based on the requirements of the load 110 and power shedding capabilities.

In the example of FIG. 9, the enable signal 902 transitions from a low voltage to a high voltage at TO and the enable signal 904 transitions from a low voltage to a high voltage at T3. Accordingly, the local controller circuitry 206A generates pulses in the clock signals 316A and 318A between TO and T3 without synchronizing with other local controllers (as shown with EN_SYNC signal 701A being set to a low voltage from TO until after T2).

Notably, programmable circuitry waits to transition the enable signal 904 to a high voltage until T3, at the rising edge of a pulse in the clock signal 318A. Accordingly, both the local controller circuitry 206A and local controller circuitry 206B start a first half-cycle after T3. Also, because the programmable circuitry transitions the EN_SYNC signal 701 to a high voltage before T3 (e.g., before turning the local controller circuitry 206B on), the start of the first half-cycles after T3 also marks the start of a sync window.

In the example of FIG. 9, the local controller circuitry 206B has less V_FLY error than the local controller circuitry 206A in the first sync window. As such, the ramp signal 306B reaches V_REF 501 before the ramp signal 308A does, and the local controller circuitry 206B sends a copy of the corresponding pulse in the clock signal 318B to the local controller circuitry 206A at T4. Receiving the copy of the pulse in the clock signal 318B at the multiplexer 714A causes the local controller circuitry 206A to also fire a pulse in the clock signal 316A at approximately T4.

After T4 in the example of FIG. 9, the first sync window ends. Accordingly, the local controller circuitry 206A and 206B independently fire pulses in the clock signals 318A and 316B at different times to perform harmonic modulation. For example, the local controller circuitry 206B fires a pulse in the clock signal 316B that ends at T5 because the pulse in the clock signal 318B fired at the anticipated time (e.g., at T4 when the ramp signal 306B reached V_REF 501). In contrast, the pulse in the clock signal 316A fired before the ramp signal 308A could reach V_REF 501, so the local controller circuitry 206A fires the pulse in the clock signal 318A before T5 to decrease the amount of time that C_FLY 404 charges.

Although the second half-cycle ends in the local controller circuitry 206A before the second half-cycle of the local controller circuitry 206B, the second sync window of FIG. 9 does not start until T5 because both controllers are not ready to re-synchronize until T5. In the example of FIG. 9, the local controller circuitry 206A has less V_FLY error than the local controller circuitry 206B in the second sync window. As such, the ramp signal 308A reaches V_REF 501 before the ramp signal 306B does, and the local controller circuitry 206A sends a copy of the corresponding pulse in the clock signal 316A to the local controller circuitry 206B at T6.

After T6 in the example of FIG. 9, the second sync window ends. Accordingly, the local controller circuitry 206A and 206B independently fire pulses in the clock signals 318A and 316B at different times to perform harmonic modulation. For example, the local controller circuitry 206A fires a pulse in the clock signal 318A that ends at T7 because the pulse in the clock signal 316A fired at the anticipated time (e.g., at T6 when the ramp signal 308A reached V_REF 501). In contrast, the pulse in the clock signal 318B fired before the ramp signal 306B could reach V_REF 501, so the local controller circuitry 206B fires the pulse in clock signal 316B before T7 to decrease the amount of time that C_FLY 404 charges.

The third sync-window in the example of FIG. 9 starts at T7 when both controllers are ready to re-synchronize. In the example of FIG. 9, the local controller circuitry 206A has less V_FLY error than the local controller circuitry 206B in the third sync window.

Accordingly, the ramp signal 308A reaches V_REF 501 before the ramp signal 306B and the local controller circuitry 206A sends a copy of the pulse in the clock signal 316A at T8. After T8, the local controller circuitry 206A and 206B independently fire pulses in the clock signals 318A and 316B at different times to perform harmonic modulation as discussed above.

While an example manner of implementing the local controller circuitry 206A and/or, more generally, the controller circuitry 202 of FIG. 2 is illustrated in FIG. 3, one or more of the elements, processes, and/or devices illustrated in FIG. 3 may be combined, divided, re-arranged, omitted, eliminated, and/or implemented in any other way. Further, the example ramp generator circuitry 302A, the clock manager circuitry 304A, the PWM generator circuitry 320A and/or, more generally, the example local controller circuitry 206A and/or, more generally, the controller circuitry 202 of FIG. 2, may be implemented by hardware alone or by hardware in combination with software and/or firmware. Thus, for example, any of the example ramp generator circuitry 302A, the clock manager circuitry 304A, the PWM generator circuitry 320A and/or, more generally, the example local controller circuitry 206A and/or, more generally, the controller circuitry 202 of FIG. 2, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example local controller circuitry 206A and/or, more generally, the controller circuitry 202 of FIG. 2 may include one or more elements, processes, and/or devices in addition to, or instead of, those illustrated in FIG. 2, and/or may include more than one of any or all of the illustrated elements, processes and devices.

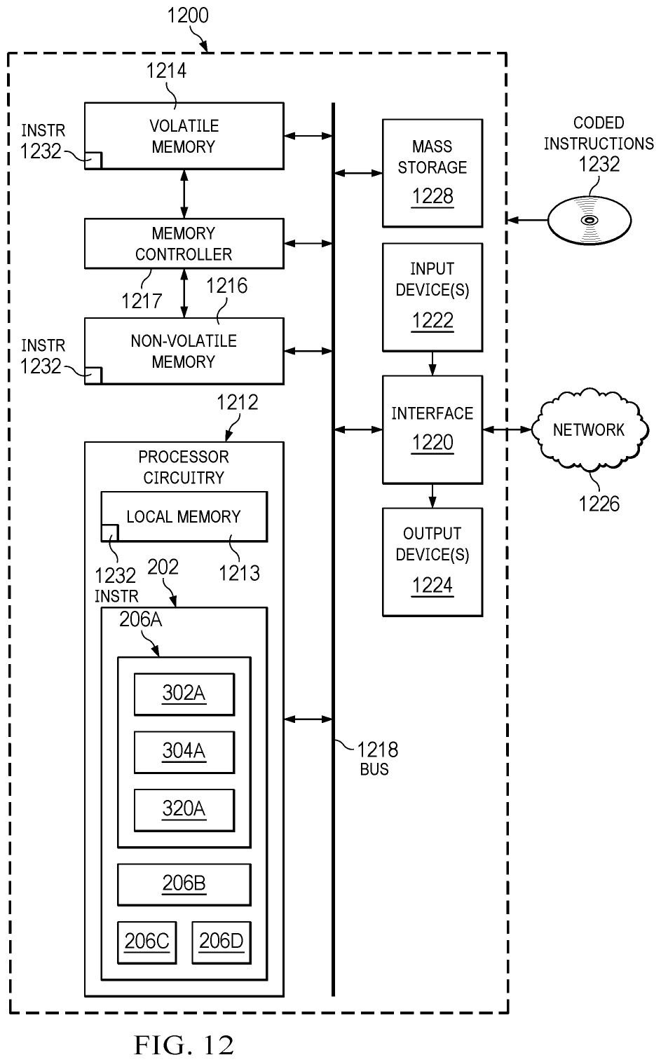

Flowchart(s) representative of example machine-readable instructions, which may be executed by programmable circuitry to implement and/or instantiate the local controller circuitry 206A and/or, more generally, the controller circuitry 202 of FIG. 2 and/or representative of example operations which may be performed by programmable circuitry to implement and/or instantiate the local controller circuitry 206A and/or, more generally, the controller circuitry 202 of FIG. 2, are shown in FIGS. 10 and 11. The machine-readable instructions may be one or more executable programs or portion(s) of one or more executable programs for execution by programmable circuitry such as the programmable circuitry 1212 shown in the example programmable circuitry platform 1200 described below in connection with FIG. 12 and/or may be one or more function(s) or portion(s) of functions to be performed by the example programmable circuitry. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 10 and 11, many other methods of implementing the example local controller circuitry 206A and/or, more generally, the controller circuitry 202 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 10 and 11 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/of” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 10 is a flowchart representative of example machine-readable instructions and/or example operations that may be executed, instantiated, and/or performed using an example programmable circuitry implementation of the local controller circuits 206A and 206B of FIG. 2. The example flowchart of FIG. 10 is divided into two columns labelled ‘206A’ and ‘206B’. Accordingly, blocks in the column labeled ‘206A’ refer to operations performed by the local controller circuitry 206A, and blocks in the column labeled ‘206B’ refer to operations performed by the local controller circuitry 206B. In the example of FIG. 10, the EN_SYNC 701 signal is set to a high voltage so both local controller circuits 206A and 206B are configured to synchronize with one another. Furthermore, the example flowchart of FIG. 10 begins at the start of a new cycle for both local controller circuits 206A and 206B.

The example machine-readable instructions and/or operations 1000 begin when the local controller circuitry 206A discharges C_FLY 404 in the power stage circuitry 204A based on local error. (Block 1002A). During the same time, the local controller circuitry 206B charges C_FLY 404 in the power stage circuitry 204B based on local error. (Block 1002B). The power stage circuitry 204A and 204B perform different operations during a synchronization window to reduce ripple in the V_OUT signal provided to the load 110 as discussed above.

The power stage circuitry 204A and 204B are two separate circuits with two separate instances of C_FLY 404. Accordingly, the magnitude of local error (e.g., V_FLY error) at block 1002A is different than the magnitude of local error at block 1002B. In examples described herein, the local controller circuitry 206A enables and disables the transistors 402 such that C_FLY 404 discharges in the first half-cycle and charges during the second half-cycle. Conversely, the local controller circuitry 206B enables and disabled the transistors 402 such that C_FLY 404 charges in the first half-cycle and discharge in the second half-cycle. Accordingly, C_FLY 404 in power stage circuitry 204A discharges at block 1002A, and C_FLY 404 in power stage circuitry 204B charges at block 1002B. In other examples, the local controller circuits 206 may enable and disable the transistors 402 in different orders.

The local controller circuitry 206A determines whether the discharge of block 1002A is complete. (Block 1004A). To make the determination of block 1004A, the comparator circuitry 706A compares the ramp signal 308A to V_REF 501. Similarly, the local controller circuitry 206B determines whether the charge of block 1002B is complete (Block 1004B).

If the ramp signal 308A has not reached V_REF 501 (Block 1004A: No), control returns to block 1002A where the C_FLY 404 in the power stage circuitry 204A continues to discharge. Similarly, if the ramp signal 306B has not reached V_REF 501 (Block 1004B: No), control returns to block 1002B where the C_FLY 404 in the power stage circuitry 204B continues to charge.

In the example of FIG. 10, the power stage circuitry 204A has less V_FLY error than the power stage circuitry 204B. Accordingly, the ramp signal 308A does reach V_REF 501 (Block 1004A: Yes), while the ramp signal 306B does not reach V_REF 501 (Block 1004B: No). After the ramp signal reaches V_REF 501, the clock generator circuitry 710A fires a pulse in a first local clock signal (e.g., the clock signal 316A). (Block 1006A). The clock generator circuitry 710A also sends a copy of the pulse to the local controller circuitry 206B. (Block 1008A). In some examples, the copy of the pulse at block 1008A may be referred to as a message or an instruction.

In response to receiving the copy of the pulse at block 1008A, the power stage circuitry 204B fires a pulse in a first local clock signal (e.g., clock signal 318B). (Block 1006B). The pulses in blocks 1006A and 1006B are synchronized because they occur at approximately the same time.

The local controller circuitry 206A fires a pulse in a second local clock signal (e.g., the clock signal 318A) based on the first local clock signal. (Block 101A). In particular, the pulse in the clock signal 318A is fired at a time that allows for a specific amount of C_FLY charging to achieve harmonic modulation in the power stage circuitry 204A. Similarly, the local controller circuitry 206B fires a pulse in a second local clock signal (e.g., the clock signal 316B) based on the first local clock signal. (Block 1010B). The pulse in the clock signal 316B also achieves harmonic modulation in the power stage circuitry 204B. Block 1010A and 1010B are implemented at different times because the power stage circuitry 204A had less V_FLY error in the example of FIG. 10 than the power stage circuitry 204B.

After the pulse in the clock signal 318A is fired, the second half-cycle ends and the local controller circuitry 206A determines whether to generate additional clock and PWM pulses in another cycle. (Block 1012A). The local controller circuitry 206A may enter another cycle whenever permitted to do so by the controller circuitry 202 via the enable signal 902. Programmable circuitry within the controller circuitry 202 may disable or enable another cycle for the local controller circuitry 206A for any reason. Similarly, the local controller circuitry 206B determines whether to generate additional clock and PWM pulses in another cycle. (Block 1012B). In the example of FIG. 10, the decision blocks of 1012A and 1012B occur at different times because the length of the power stage circuitry 204A cycle is unequal the length of the power stage circuitry 204B.

If the local controller circuitry 206A enters another cycle (Block 1012A: Yes), control returns to block 1002A where the local controller circuitry 206A causes C_FLY 404 to discharge as part of the first stage of the power stage circuitry 204A. If the local controller circuitry 206A does not enter another cycle (Block 1012A: No), the machine-readable instructions and/or operations 1000 for the local controller circuitry 206A end.

Similarly, if the local controller circuitry 206B enters another cycle (Block 1012B: Yes), control returns to block 1002B where the local controller circuitry 206B causes C_FLY 404 to charge as part of the first stage of the power stage circuitry 204B. If the local controller circuitry 206B does not enter another cycle (Block 1012B: No), the machine-readable instructions and/or operations 1000 for the local controller circuitry 206B end.

FIG. 11 is a flowchart representative of example machine-readable instructions and/or example operations that may be executed, instantiated, and/or performed using an example programmable circuitry implementation of the clock manager circuitry 304A of FIG. 3. The example machine-readable instructions and/or operations 1100 begin when the clock manager circuitry 304A determines whether to engage in synchronization with other local controllers. (Block 1102). The clock manager circuitry 304A makes the determination based on the value of the EN_SYNC signal 701 as discussed above in connection with FIG. 7. If the clock manager circuitry 304A determines not to engage in synchronization with other local controllers (Block 1102: No), the example machine-readable instructions and/or operations 1100 end.

If the clock manager circuitry 304A determines to engage in synchronization with other local controllers (Block 1102: Yes), the comparator circuitry 706A monitors the voltage of a synchronized local ramp signal and an unsynchronized local ramp signals where the slopes of the ramp signals are indicative of C_FLY charge and discharge rates. (Block 1104). In examples described herein, the ramp signals 308A and 306B are synchronized local ramp signals and the ramp signals 306A and 308B are unsynchronized local ramp signals. Additionally, in examples described herein, the ramp signals 308A and 308B are indicative of C_FLY discharge rates while the ramp signals 306A and 306B are indicative of C_FLY charge rates. In other examples, ramp signals with other indices are synchronized/unsynchronized and/or indicative of C_FLY charging/discharging rates.

The comparator circuitry 706A determines whether the synchronized local ramp signal has exceeded a reference voltage. (Block 1106). In examples, described herein, the reference voltage is referred to as V_REF 501 and is proportional to V_IN provided by the DC power supply unit 106. In other examples, the reference voltage is a different value. If the synchronized local ramp signal has not exceeded the reference voltage (Block 1106: No), the comparator circuitry 706A waits for a period (Block 1108) before control returns to block 1106.

While the comparator circuitry 706A implements blocks 1106 and 1108, the multiplexer 714A also monitors the bus 205 for an instruction (e.g., a copy of a clock pulse) from the local controller circuitry 206B. In some examples, V_FLY error in the local controller circuitry 206A has smaller magnitude than that in the local controller circuitry 206B, so the ramp signal 308A exceeds V_REF 501 before the instruction is received from the local controller circuitry 206B. In other examples, V_FLY error in the local controller circuitry 206A has greater magnitude than that in the local controller circuitry 206B, so the instruction is received before ramp signal 308A crosses V_REF 501.

If V_FLY error in the power stage circuitry 204A has smaller magnitude than that in the power stage circuitry 204B, then the synchronized local ramp signal eventually exceeds the reference voltage (Block 1106: Yes). The reference voltage being met or exceeded at block 1106 causes the clock generator circuitry 710A to fire a pulse in the synchronized clock signal (e.g., clock signal 316A) (Block 1110). The reference voltage being met or exceeded at block 1106 also causes the clock manager circuitry 304A to send an instruction that causes an external controller (e.g., local controller circuitry 206B) to fire a pulse in a synchronized clock signal (e.g., clock signal 316B). (Block 1112). In such examples, the local controller circuitry 206A does not implement blocks 1114 or 1116 in the current cycle.

Alternatively, if the V_FLY error in the power stage circuitry 204A has a larger magnitude than that in the power stage circuitry 204B, then the multiplexer 714A receives an instruction from an external controller (e.g., local controller circuitry 206B). (Block 1114). In examples described herein, the instruction is a copy of a pulse in the clock signal 318B. In other examples, the instruction is formatted differently (e.g., an interrupt, a bit flag, etc.).

The clock manager circuitry 304A fires a pulse in the synchronized local clock signal based on the instruction. (Block 1116). In such examples where the V_FLY error in the local controller circuitry 206A has larger magnitude than that in the local controller circuitry 206B, then the local controller circuitry 206A does not implement blocks 1106-1112 in the current cycle.

The clock manager circuitry 304A fires a pulse in the unsynchronized local clock signal (e.g., clock signal 318A) when the voltage of the unsynchronized ramp (e.g., ramp signal 306A) enables regulation of C_FLY 404 through harmonic modulation. (Block 1118). For example, the local controller circuitry 206A may fire the pulse in the clock signal 318A later (thereby allowing more time for C_FLY 404 to charge) if harmonic modulation for the current cycle calls for a net increase in charge at C_FLY 404. The local controller circuitry 206A implements block 1118 regardless of whether the pulse in the synchronized clock signal was fired at block 1110 or 1116. Accordingly, the pulse of block 1118 may be fired at a time that accounts for the fact that the pulse in the synchronized clock signal fired earlier than expected (e.g., at block 1116).

The clock manager circuitry 304A determines whether the ramp signals 306A and 308A are still active. (Block 1120). The ramp signals 306A, 308A may become inactive if the control circuitry 202 disables the local controller circuitry 206A during power shedding operations. If the ramp signals 306A, 308A are still active (Block 1120: Yes), then control returns to block 1104 where the comparator circuitry 706A monitors the voltage of both ramp signals. Alternatively, if the ramp signals 306A, 308A are not active (Block 1120: No), the machine-readable instructions and/or operations 1100 end.

FIG. 12 is a block diagram of an example programmable circuitry platform 1200 structured to execute and/or instantiate the example machine-readable instructions and/or the example operations of FIGS. 10 and 11 to implement the local controller circuitry 206A and/or, more generally, the controller circuitry 202 of FIG. 2. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, and/or microcontrollers from any desired family or manufacturer. The programmable circuitry 1212 may be implemented by one or more semiconductor based (e.g., silicon based) devices. In this example, the programmable circuitry 1212 implements the ramp generator circuitry 302A, the clock manager circuitry 304A, the PWM generator circuitry 320A, and/or, more generally, the local controller circuits 206, and/or, more generally, the controller circuitry 202.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated examples is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1232, which may be implemented by the machine-readable instructions of FIGS. 10 and 11, may be stored in the mass storage device 1228, in the volatile memory 1214, in the non-volatile memory 1216, and/or on at least one non-transitory computer readable storage medium such as a CD or DVD which may be removable.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Numerical identifiers such as “first”, “second”, “third”, etc. are used merely to distinguish between elements of substantially the same type in terms of structure and/or function. These identifiers as used in the detailed description do not necessarily align with those used in the claims.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

As used herein, “approximately” and “about” modify their subjects/values to recognize the potential presence of variations that occur in real world applications. For example, “approximately” and “about” may modify dimensions that may not be exact due to manufacturing tolerances, signal propagation delays, and/or other real world imperfections as will be understood by persons of ordinary skill in the art. Unless otherwise stated, “about,” “approximately,” or “substantially” preceding a value means +/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been described that synchronize outputs of power stage circuits while also using harmonic modulation to correct for V_FLY error that may independently vary between power stage circuits. Described systems, apparatus, articles of manufacture, and methods improve the efficiency of using a computing device by using a first of two clock signals that are synchronized globally, where the local controller circuit connected to the power stage circuit with the smallest magnitude V_FLY error fires its synchronized clock pulse first and causes all other synchronizing controllers to fire a pulse in the synchronous clock signals. The synchronized then independently perform harmonic modulation by firing a pulse in the second clock signal at a specific time based on when the pulse in the first clock signal was fired (thereby achieving a net increase or decrease to the charge on a fly capacitor needed to correct and/or mitigate the V_FLY error). Described systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

What is claimed is:

1. An apparatus to control a power stage circuit, the apparatus comprising programmable circuitry configured to:
generate, in response to an instruction from an external controller, a pulse in a first local clock signal, the pulse in the first local clock signal generated when a fly capacitor in the power stage circuit has discharged for a discharge period that is less than a threshold amount of time; and
generate a pulse in a second local clock signal after the fly capacitor has charged for a charge period, wherein a length of the charge period is based on the length of the discharge period.

2. The apparatus of claim 1, wherein:
the power stage circuit is a first power stage circuit;
the external controller corresponds to a second power stage circuit having a second error;
the first power stage circuit has a first error proportional to a difference between the length of the charge period and the length of the discharge period; and
the programmable circuitry is to receive the instruction from the external controller before the threshold amount of time because the second error is smaller than the first error.

3. The apparatus of claim 2, wherein:
the programmable circuitry is to generate one or more pulses in the first local clock signal and second local clock signal such that a duty cycle of the discharge period and a first disconnection period within the first power stage circuit is equal to a duty cycle of the charge period and a second disconnection period within the first power stage circuit; and
a total length of the discharge period, the first disconnection period, the charge period, and the second disconnection period of the first power stage circuit is longer than a total length of corresponding periods in the second power stage circuit because the second error is smaller than the first error.

4. The apparatus of claim 1, wherein:
the power stage circuit is a first power stage circuit;
the external controller corresponds to a second power stage circuit;
the first power stage circuit delivers power to a load based on pulses in the first local clock signal and the second local clock signal;
the second power stage circuit delivers power to the load based on pulses in a first external clock signal and a second external clock signal; and
the programmable circuitry is to synchronize, based on the instruction, the generation of a pulse in the first local clock signal with a generation of a pulse the first external clock signal.

5. The apparatus of claim 1, wherein:
the pulse in the first local clock signal is a first synchronization pulse;
the pulse in the second local clock signal is a first harmonic modulation pulse; and
the programmable circuitry is to fire the first harmonic modulation pulse before firing a second synchronization pulse.

6. The apparatus of claim 5, wherein:
the first synchronization pulse and the first harmonic modulation pulse correspond to a first cycle;
the second synchronization pulse and a second harmonic modulation pulse correspond to a second cycle;
an error in the power stage circuit during the second cycle is less than the error in the power stage circuit during the first cycle; and
a length of the first cycle is greater than a length of the second cycle.

7. An apparatus comprising:
comparator circuitry configured to:
receive a ramp signal having a slope that is modulated proportional to a discharge period of a fly capacitor in a power stage circuit; and
generate an output voltage in response to a determination that the ramp signal exceed a reference voltage; and
clock generator circuitry to:
produce, in response to a determination that the comparator circuitry generated the output voltage before an external controller generated a pulse in an external clock signal, a pulse in a first local clock signal;
cause, in response to producing the pulse in the first local clock signal, the external controller to generate the pulse in the external clock signal; and
generate a pulse in a second local clock signal after the fly capacitor has charged for a charge period, wherein a length of the charge period is based on the length of the discharge period.

8. The apparatus of claim 7, wherein:
the power stage circuit is a first power stage circuit and the fly capacitor is a first fly capacitor, the first power stage circuit having a first error proportional to a difference between the length of the charge period and the length of the discharge period;
the external controller is a second power stage circuit having a second error based on a second fly capacitor; and
the clock generator circuitry is further to determine, based on the comparator circuitry generating the output voltage before the external controller generated the pulse in the external clock signal, that the first error is smaller than the second error.

9. The apparatus of claim 8, wherein:
the clock generator circuitry is to generate one or more pulses in the first local clock signal and second local clock signal such that a duty cycle of the discharge period and a first disconnection period within the first power stage circuit is equal to a duty cycle of the charge period and a second disconnection period within the first power stage circuit; and
a total length of the discharge period, the first disconnection period, the charge period, and the second disconnection period of the first power stage circuit is shorter than a total length of corresponding periods in the second power stage circuit because the first error is smaller than the second error.

10. The apparatus of claim 8, wherein:
the first power stage circuit delivers power to a load based on pulses in the first local clock signal and the second local clock signal;
the external clock signal is a first external clock signal; and
the second power stage circuit delivers power to the load based on pulses in the first external clock signal and a second external clock signal.

11. The apparatus of claim 7, further including ramp generator circuitry to change the slope of the ramp signal based on an error in the fly capacitor.

12. The apparatus of claim 7, wherein:
the pulse in the first local clock signal is a first synchronization pulse;
the pulse in the second local clock signal is a first harmonic modulation pulse; and
the comparator circuitry is to fire the first harmonic modulation pulse before firing a second synchronization pulse.

13. The apparatus of claim 12, wherein:
the first synchronization pulse and the first harmonic modulation pulse correspond to a first cycle;
the second synchronization pulse and a second harmonic modulation pulse correspond to a second cycle;
an error in the fly capacitor during the second cycle is less than the error in the fly capacitor during the first cycle; and
a length of the first cycle is greater than a length of the second cycle.

14. A method comprising:
receiving a ramp signal having a slope that is modulated proportional to a discharge period of a fly capacitor in a power stage circuit;
generating an output voltage in response to a determination that the ramp signal exceed a reference voltage;
producing, in response to generating the output voltage before an external controller generated a pulse in an external clock signal, a pulse in a first local clock signal;
causing, in response to producing the pulse in the first local clock signal, the external controller to generate the pulse in the external clock signal; and
generating a pulse in a second local clock signal after the fly capacitor has charged for a charge period, wherein a length of the charge period is based on the length of the discharge period.

15. The method of claim 14, wherein:
the power stage circuit is a first power stage circuit and the fly capacitor is a first fly capacitor, the first power stage circuit having a first error proportional to a difference between the length of the charge period and the length of the discharge period;
the external controller is a second power stage circuit having a second error based on a second fly capacitor; and
the method further includes determining, based on generating the output voltage before the external controller generated the pulse in the external clock signal, that the first error is smaller than the second error.

16. The method of claim 15, wherein:
the method further includes generating one or more pulses in the first local clock signal and second local clock signal such that a duty cycle of the discharge period and a first disconnection period within the first power stage circuit is equal to a duty cycle of the charge period and a second disconnection period within the first power stage circuit; and
a total length of the discharge period, the first disconnection period, the charge period, and the second disconnection period of the first power stage circuit is shorter than a total length of corresponding periods in the second power stage circuit because the first error is smaller than the second error.

17. The method of claim 15, wherein:
the external clock signal is a first external clock signal; and
the method further includes:
delivering, with the first power stage circuit, power to a load based on pulses in the first local clock signal and the second local clock signal; and
delivering, with the second power stage circuit, power to the load based on pulses in the first external clock signal and a second external clock signal.

18. The method of claim 14, further including changing the slope of the ramp signal based on an error in the fly capacitor.

19. The method of claim 14, wherein:
the pulse in the first local clock signal is a first synchronization pulse;
the pulse in the second local clock signal is a first harmonic modulation pulse; and
the method further includes firing the first harmonic modulation pulse before firing a second synchronization pulse.

20. The method of claim 19, wherein:
the first synchronization pulse and the first harmonic modulation pulse correspond to a first cycle;
the second synchronization pulse and a second harmonic modulation pulse correspond to a second cycle;
an error in the fly capacitor during the second cycle is less than the error in the fly capacitor during the first cycle; and
a length of the first cycle is greater than a length of the second cycle.
